(19) United States
(12) Patent Application Publication
(10) Pub. No.: US 2025/0374069 A1
(43) Pub. Date: Dec. 4, 2025

(54) METHODS TO DYNAMICALLY OPTIMIZE TIME-TO-FIRST-FIX UNDER RESTRICTED GNSS CONDITIONS

(71) Applicant: QUALCOMM Incorporated, San Diego, CA (US)

(72) Inventors: Fnu SIDDHANT, Bangalore (IN); Jordan COOKMAN, San Jose, CA (US); Mukesh KUMAR, Hyderabad (IN)

(21) Appl. No.: 18/676,294

(22) Filed: May 28, 2024

(51) Int. Cl. H04W 16/24; H04W 84/04; H04W 84/06

(52) U.S. Cl. CPC H04W 16/24; H04W 84/042; H04W 84/06

(57) ABSTRACT

An example method for Global Navigation Satellite System (GNSS)-based positioning performed by a GNSS device, the method may include receiving, from a terrestrial network, Public Land Mobile Network (PLMN) information of the GNSS device, indicating a region in which the GNSS device is located and obtaining a coverage association mapping radio frequency signal coverages of a plurality of satellites with one or more fixed radio cells of the terrestrial network, wherein the coverage association is determined based on orbital information of the plurality of satellites. The method may also include determining a list of satellites based on the coverage association and the region indicated by the PLMN information and determining one or more satellites from the list with which to perform a GNSS session by searching satellites on the list in accordance with a priority established in the list.

### TECHNICAL FIELD

The present disclosure relates generally to the field of satellite-based positioning and more specifically relates to Global Navigation Satellite System (GNSS)-based positioning with improved time-to-first-fix (TTFF).

### BACKGROUND

GNSS positioning of mobile devices (e.g., consumer electronics, vehicles, assets, drones, etc.) can provide accurate positioning of a mobile device comprising a GNSS receiver (also referred as a GNSS device). To achieve accurate positioning, the GNSS device typically requires a clear line-of-sight to multiple satellites. In scenarios where satellite visibility is and/or had been compromised, the GNSS device may utilize algorithms to search for satellites for reconnecting with the satellites, potentially extending the TTFF (e.g., the time required for the GNSS device to acquire satellite signals and calculate a position solution).

### BRIEF SUMMARY

An example method for Global Navigation Satellite System (GNSS)-based positioning performed by a GNSS device, the method may include receiving, from a terrestrial network, Public Land Mobile Network (PLMN) information of the GNSS device, indicating a region in which the GNSS device is located and obtaining a coverage association mapping radio frequency signal coverages of a plurality of satellites with one or more fixed radio cells of the terrestrial network, wherein the coverage association is determined based on orbital information of the plurality of satellites. The method may also include determining a list of satellites based on the coverage association and the region indicated by the PLMN information and determining one or more satellites from the list with which to perform a GNSS session by searching satellites on the list in accordance with a priority established in the list.

An example Global Navigation Satellite System (GNSS) device for GNSS-based positioning may comprise one or more transceivers, one or more memories, and one or more processors communicatively coupled with the one or more transceivers and the one or more memories. The one or more processors may be configured to receive, from a terrestrial network, Public Land Mobile Network (PLMN) information of the GNSS device, indicating a region in which the GNSS device is located and obtain a coverage association mapping radio frequency signal coverages of a plurality of satellites with one or more fixed radio cells of the terrestrial network, wherein the coverage association is determined based on orbital information of the plurality of satellites. The one or more processors may also be configured determine a list of satellites based on the coverage association and the region indicated by the PLMN information and determine one or more satellites from the list with which to perform a GNSS session by searching satellites on the list in accordance with a priority established in the list.

An example apparatus for Global Navigation Satellite System (GNSS)-based positioning, the method may include means for receiving, from a terrestrial network, Public Land Mobile Network (PLMN) information of the apparatus, indicating a region in which the GNSS device is located and means for obtaining a coverage association mapping radio frequency signal coverages of a plurality of satellites with one or more fixed radio cells of the terrestrial network, wherein the coverage association is determined based on orbital information of the plurality of satellites. The apparatus may also include means for determining a list of satellites based on the coverage association and the region indicated by the PLMN information and means for determining one or more satellites from the list with which to perform a GNSS session by searching satellites on the list in accordance with a priority established in the list.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is an illustration of a communication/positioning/sensing system, according to an embodiment.

FIG. 2 is diagram of a fifth-generation new radio (5G NR) network, according to an embodiment.

FIG. 3 is a simplified diagram of a Global Navigation Satellite System (GNSS), according to an embodiment.

FIG. 4 illustrates a call flow diagram for an improved GNSS session, according to some embodiments.

FIG. 5 illustrates a coverage association mapping radio frequency signal coverages of a plurality of satellites with one or more fixed radio cells of a terrestrial network, according to some embodiments.

FIG. 6 is a flow diagram of a method of the improved GNSS session illustrated in FIG. 4, performed by a GNSS device, according to some embodiments.

FIG. 7 is a block diagram of an embodiment of a GNSS device, which can be utilized in embodiments as described herein.

FIG. 8 is a block diagram of an embodiment of a computer system, which can be utilized in embodiments as described herein.

FIG. 9 is a block diagram of an embodiment of a base station, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

Several illustrative examples concerning the accompanying drawings will now be described, which form a part hereof. While particular examples in which one or more aspects of the disclosure may be implemented are described below, other examples may be used, and various modifications may be made without departing from the scope of the disclosure.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification do not necessarily refer to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the terms “mobile device” and “User Equipment” (UE) may be used interchangeably and are not intended to be specific or otherwise limited to any particular Radio Access Technology (RAT) unless otherwise noted. In general, a mobile device and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IoT) device, etc.), or another electronic device that may be used for Global Navigation Satellite Systems (GNSS) positioning as described herein. According to some embodiments, a mobile device and/or UE may be used to communicate over a wireless communications network. A UE may be mobile or may (e.g., at certain times) be stationary and may communicate with a Radio Access Network (RAN). As used herein, the term UE may be referred to interchangeably as an Access Terminal (AT), a client device, a wireless device, a subscriber device, a subscriber terminal, a subscriber station, a user terminal (UT), a mobile device, a mobile terminal, a mobile station, or variations thereof. Generally, UEs can communicate with a core network via a RAN, and through the core network, the UEs can be connected with external networks (such as the Internet) and with other UEs. Other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 standard, etc.), and so on.

A “space vehicle” (SV), as referred to herein, relates to an object that is capable of transmitting signals to receivers on the Earth's surface. In one particular example, such an SV may comprise a geostationary satellite. Alternatively, an SV may comprise a satellite traveling in an orbit and moving relative to a stationary position on the Earth. However, these are merely examples of SVs and the claimed subject matter is not limited in these respects. SVs also may be referred to herein simply as “satellites.”

As described herein, a GNSS receiver (also may be referred as a GPS receiver in some examples) may comprise and/or be incorporated into an electronic device. This may include a single entity or may include multiple entities, such as in a personal area network where a user may employ audio, video, and/or data I/O devices and/or body sensors and a separate wireline or wireless modem. As described herein, an estimate of the location of a GNSS receiver may be referred to as a location, location estimate, location fix, fix, position, position estimate, or position fix and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

GNSS positioning of mobile devices (e.g., consumer electronics, vehicles, assets, drones, etc.) can provide accurate positioning of a mobile device comprising a GNSS receiver (also referred as a GNSS device). To achieve accurate positioning, the GNSS device typically requires a clear line-of-sight to multiple satellites. In scenarios where satellite visibility is and/or had been compromised, the GNSS device may utilize algorithms to search for satellites for reconnecting with the satellites, potentially extending the time-to-first-fix (TTFF) (e.g., the time required for a GPS navigation device to acquire satellite signals and calculate a position solution), which is a key performance metric in GNSS operations. The efficiency of TTFF may be heavily influenced by the receiver's ability to quickly acquire and process satellite signals. That said, the initial signal acquisition, during which phase, the GNSS receiver searches for and locks onto satellite signals to begin computing its position, is an important phase in GNSS operations that directly impacts TTFF.

Various aspects relate generally to the field of satellite-based positioning and more specifically relates to GNSS-based positioning with improved TTFF, based on Public Land Mobile Network (PLMN) information from a terrestrial network. In some embodiments, when initiating a GNSS session, PLMN information indicating a region in which the GNSS device is located may be received by the GNSS device from the terrestrial network. Additionally, a coverage association mapping radio frequency signal coverages of a plurality of satellites with one or more fixed radio cells of the terrestrial network may also be obtained by the GNSS device. In some embodiments, a list of satellites may be determined according to the coverage association and the region indicated by the PLMN information. One or more satellites from the list, with which the GNSS device will perform the GNSS session, may be determined by searching satellites on the list in accordance with searching strategies (e.g., a search order and a back-off strategy) established in the list.

Particular aspects of the subject matter described in this disclosure can be implemented to realize one or more of the following potential advantages. In some examples, by using the list determined based on the region indicated by the PLMN information and the coverage association mapping of radio frequency signal coverages of a plurality of satellites with one or more fixed radio cells of the terrestrial network, TTFF of a GNSS session can be significantly reduced, and thus, the performance of GNSS-based positioning can be enhanced. Additionally, in cases where the GNSS device is located in a GNSS-denied region (e.g., where no GNSS signals will be received), the GNSS device can determine this fact more efficiently (e.g., using less time and power) based on the search order and the back-off strategy established in the list.

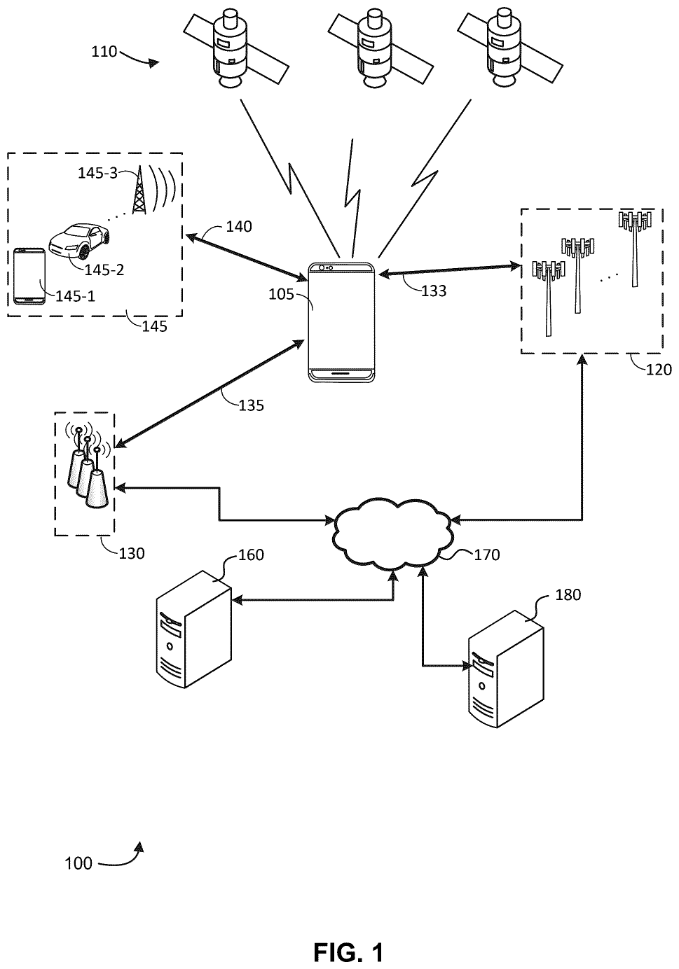

FIG. 1 is a simplified illustration of a wireless system capable of communication and positioning, referred to herein as a “communication/positioning system” 100 in which a mobile device 105, network function server 160, and/or other components of the communication/positioning 100 can use the techniques provided herein for GNSS-based positioning with improved TTFF disclosed herein, according to an embodiment. (That said, embodiments are not necessarily limited to such a system.) The techniques described herein may be implemented by one or more components of the communication/positioning 100. The communication/positioning 100 can include: a mobile device 105; one or more satellites 110 (also referred to as space vehicles (SVs)), which may include Global Navigation Satellite System (GNSS) satellites (e.g., satellites of the Global Positioning System (GPS), GLONASS, Galileo, Beidou, etc.) and or Non-Terrestrial Network (NTN) satellites; base stations 120; access points (APs) 130; network function server 160; network 170; and external client 180. Generally put, the communication/positioning 100 may be capable of enabling communication between the mobile device 105 and other devices, positioning of the mobile device 105 and/or other devices, performing RF sensing by the mobile device 105 and/or other devices, or a combination thereof. For example, the communication/positioning 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additionally or alternatively, wireless devices such as the mobile device 105, base stations 120, and satellites 110 (and/or other NTN platforms, which may be implemented on airplanes, drones, balloons, etc.) can be utilized to perform positioning (e.g., of one or more wireless devices) and/or perform RF sensing (e.g., of one or more objects by using RF signals transmitted by one or more wireless devices).

It should be noted that FIG. 1 provides only a generalized illustration of various components, any or all of which may be utilized as appropriate, and each of which may be duplicated as necessary. Specifically, although only one mobile device 105 is illustrated, it will be understood that many UEs (e.g., hundreds, thousands, millions, etc.) may utilize the communication/positioning 100. Similarly, the communication/positioning 100 may include a larger or smaller number of base stations 120 and/or APs 130 than illustrated in FIG. 1. The illustrated connections that connect the various components in the communication/positioning 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to network function server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). In and LTE, 5G, or other cellular network, mobile device 105 may be referred to as a user equipment (UE). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUs), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as network function server 160, by accessing the network 170 via a base station 120 using a first communication link 133. Additionally or alternatively, because APs 130 also may be communicatively coupled with the network 170, mobile device 105 may communicate with network-connected and Internet-connected devices, including network function server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). According to aspects of applicable 5G cellular standards, a base station 120 (e.g., gNB) may be capable of transmitting different “beams” in different directions and performing “beam sweeping” in which a signal is transmitted in different beams, along different directions (e.g., one after the other). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

Satellites 110 may be utilized for positioning in communication in one or more way. For example, satellites 110 (also referred to as space vehicles (SVs)) may be part of a Global Navigation Satellite System (GNSS) such as the Global Positioning System (GPS), GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for NTN-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120 and may be coordinated by a network function server 160, which may operate as a location server. In some embodiments, satellites 110 used for NTN-based positioning may be different than those used for GNSS-based positioning. In some embodiments NTN nodes may include non-terrestrial vehicles such as airplanes, balloons, drones, etc., which may be in addition or as an alternative to NTN satellites. NTN satellites 110 and/or other NTN platforms may be further leveraged to perform RF sensing. As described in more detail hereafter, satellites may use a JCS symbol in an Orthogonal Frequency-Division Multiplexing (OFDM) waveform to allow both RF sensing and/or positioning, and communication.

The network function server 160 may comprise one or more servers and/or other computing devices configured to provide a network-managed and/or network-assisted function, such as operating as a location server and/or sensing server. A location server, for example, may determine an estimated location of mobile device 105 and/or provide data (e.g., “assistance data”) to mobile device 105 to facilitate location measurement and/or location determination by mobile device 105. According to some embodiments, a location server may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in the location server. In some embodiments, the location server may comprise, a Discovered SLP (D-SLP) or an Emergency SLP (E-SLP). The location server may also comprise an Enhanced Serving Mobile Location Center (E-SMLC) that supports location of mobile device 105 using a control plane (CP) location solution for LTE radio access by mobile device 105. The location server may further comprise a Location Management Function (LMF) that supports location of mobile device 105 using a control plane (CP) location solution for NR or LTE radio access by mobile device 105.

Similarly, the network function server 160, may function as a sensing server. A sensing server can be used to coordinate and/or assist in the coordination of sensing of one or more objects (also referred to herein as “targets”) by one or more wireless devices in the communication/positioning 100. This can include the mobile device 105, base stations 120, APs 130, other mobile devices 145, satellites 110, or any combination thereof. Wireless devices capable of performing RF sensing may be referred to herein as “sensing nodes.” To perform RF sensing, a sensing server may coordinate sensing sessions in which one or more RF sensing nodes may perform RF sensing by transmitting RF signals (e.g., reference signals (RSS)), and measuring reflected signals, or “echoes,” comprising reflections of the transmitted RF signals off of one or more objects/targets. Reflected signals and object/target detection may be determined, for example, from channel state information (CSI) received at a receiving device. Sensing may comprise (i) monostatic sensing using a single device as a transmitter (of RF signals) and receiver (of reflected signals); (ii) bistatic sensing using a first device as a transmitter and a second device as a receiver; or (iii) multi-static sensing using a plurality of transmitters and/or a plurality of receivers. To facilitate sensing (e.g., in a sensing session among one or more sensing nodes), a sensing server may provide data (e.g., “assistance data”) to the sensing nodes to facilitate RS transmission and/or measurement, object/target detection, or any combination thereof. Such data may include an RS configuration indicating which resources (e.g., time and/or frequency resources) may be used (e.g., in a sensing session) to transmit RS for RF sensing. According to some embodiments, a sensing server may comprise a Sensing Management Function (SMF).

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), Ultra Wideband (UWB), IEEE 802.15x, or a combination thereof. Mobile devices 145 may additionally or alternatively use non-RF wireless signals for positioning of the mobile device 105, such as infrared signals or other optical technologies.

An estimated location of mobile device 105 can be used in a variety of applications—e.g., to assist direction finding or navigation for a user of mobile device 105 or to assist another user (e.g., associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another UE) at some known previous time). A location may be specified as a geodetic location comprising coordinates which may be absolute (e.g., latitude, longitude and optionally altitude), relative (e.g., relative to some known absolute location) or local (e.g., X, Y and optionally Z coordinates according to a coordinate system defined relative to a local area such a factory, warehouse, college campus, shopping mall, sports stadium or convention center). A location may instead be a civic location and may then comprise one or more of a street address (e.g., including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g., a circle or ellipse) within which mobile device 105 is expected to be located with some level of confidence (e.g., 95% confidence).

The external client 180 may be a web server or remote application that may have some association with mobile device 105 (e.g., may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

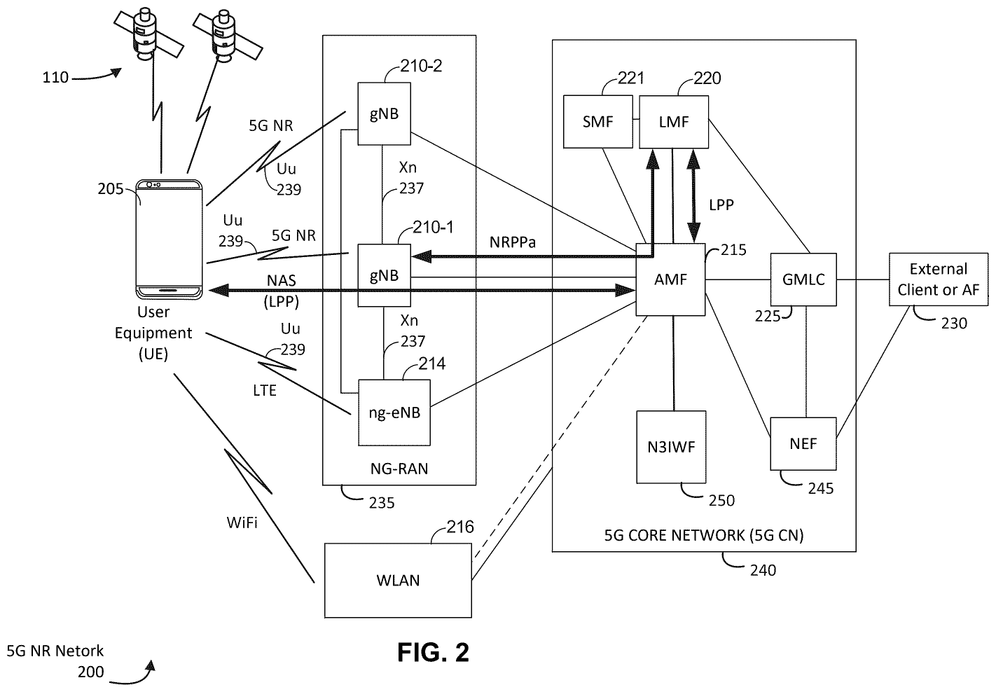

As previously noted, the example communication/positioning 100 can be implemented using a wireless communication network, such as an LTE-based or 5G NR-based network, or a future 6G network. FIG. 2 shows a diagram of a 5G NR network 200, illustrating an embodiment of a wireless system (e.g., communication/positioning 100) implemented in 5G NR. The 5G NR network 200 may be configured to enable wireless communication, determine the location of a UE 205 (which may correspond to the mobile device 105 of FIG. 1), facilitate GNSS-based positioning with improved TTFF disclosed herein, or a combination thereof, by using access nodes, which may include NR NodeB (gNB) 210-1 and 210-2 (collectively and generically referred to herein as gNBs 210), ng-eNB 214, and/or WLAN 216. These access nodes can use RF signaling to enable the communication, implement one or more positioning methods, and/or implement RF sensing. The gNBs 210 and/or the ng-eNB 214 may correspond with base stations 120 of FIG. 1, and the WLAN 216 may correspond with one or more access points 130 of FIG. 1. Optionally, the 5G NR network 200 additionally may be configured to determine the location of a UE 205 by using an LMF 220 (which may correspond with location server 160) to implement the one or more positioning methods. The SMF 221 may coordinate RF sensing by the 5G NR network 200. Here, the 5G NR network 200 comprises a UE 205, and components of a 5G NR network comprising a Next Generation (NG) Radio Access Network (RAN) (NG-RAN) 235 and a 5G Core Network (5G CN) 240. A 5G NR network 200 may also be called a 5G network and/or an NR network; NG-RAN 235 may be referred to as a 5G RAN or as an NR RAN; and 5G CN 240 may be referred to as an NG Core network. Additional components of the 5G NR network 200 are described below. The 5G NR network 200 may include additional or alternative components.

The 5G NR network 200 may further utilize information from satellites 110. As previously indicated, satellites 110 may comprise GNSS satellites from a GNSS system like Global Positioning System (GPS) or similar system (e.g. GLONASS, Galileo, Beidou, Indian Regional Navigational Satellite System (IRNSS)). Additionally or alternatively, satellites 110 may comprise NTN satellites that may be communicatively coupled with the LMF 220 and may operatively function as a TRP (or TP) in the NG-RAN 235. As such, satellites 110 may be in communication with one or more gNB 210.

It should be noted that FIG. 2 provides only a generalized illustration of various components, any or all of which may be utilized as appropriate, and each of which may be duplicated or omitted as necessary. Specifically, although only one UE 205 is illustrated, it will be understood that many UEs (e.g., hundreds, thousands, millions, etc.) may utilize the 5G NR network 200. Similarly, the 5G NR network 200 may include a larger (or smaller) number of satellites 110, gNBs 210, ng-eNBs 214, Wireless Local Area Networks (WLANs) 216, Access and mobility Management Functions (AMF) s 215, external clients 230, and/or other components. The illustrated connections that connect the various components in the 5G NR network 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 205 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 205 may correspond to a cellphone, smartphone, laptop, tablet, personal data assistant (PDA), navigation device, Internet of Things (IoT) device, or some other portable or moveable device. Typically, though not necessarily, the UE 205 may support wireless communication using one or more Radio Access Technologies (RATs) such as using GSM, CDMA, W-CDMA, LTE, High-Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 205 may also support wireless communication using a WLAN 216 which (like the one or more RATs, and as previously noted with respect to FIG. 1) may connect to other networks, such as the Internet. The use of one or more of these RATs may allow the UE 205 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 205 (e.g., via the GMLC 225). The external client 230 of FIG. 2 may correspond to external client 180 of FIG. 1, as implemented in or communicatively coupled with a 5G NR network.

The UE 205 may include a single entity or may include multiple entities, such as in a personal area network where a user may employ audio, video and/or data I/O devices, and/or body sensors and a separate wireline or wireless modem. An estimate of a location of the UE 205 may be referred to as a location, location estimate, location fix, fix, position, position estimate, or position fix, and may be geodetic, thus providing location coordinates for the UE 205 (e.g., latitude and longitude), which may or may not include an altitude component (e.g., height above sea level, height above or depth below ground level, floor level or basement level). Alternatively, a location of the UE 205 may be expressed as a civic location (e.g., as a postal address or the designation of some point or small area in a building such as a particular room or floor). A location of the UE 205 may also be expressed as an area or volume (defined either geodetically or in civic form) within which the UE 205 is expected to be located with some probability or confidence level (e.g., 67%, 95%, etc.). A location of the UE 205 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include gNBs 210. Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 205 via wireless communication between the UE 205 and one or more of the gNBs 210, which may provide wireless communications access to the 5G CN 240 on behalf of the UE 205 using 5G NR. The wireless interface between base stations (gNBs 210 and/or ng-eNB 214) and the UE 205 may be referred to as a Uu interface 239. 5G NR radio access may also be referred to as NR radio access or as 5G radio access. In FIG. 2, the serving gNB for UE 205 is assumed to be gNB 210-1, although other gNBs (e.g. gNB 210-2) may act as a serving gNB if UE 205 moves to another location or may act as a secondary gNB to provide additional throughput and bandwidth to UE 205.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to UE 205. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 205 but may not receive signals from UE 205 or from other UEs. Some gNBs 210 (e.g., gNB 210-2 and/or another gNB not shown) and/or ng-eNB 214 may be configured to function as detecting-only nodes may scan for signals containing, e.g., PRS data, assistance data, or other location data. Such detecting-only nodes may not transmit signals or data to UEs but may transmit signals or data (relating to, e.g., PRS, assistance data, or other location data) to other network entities (e.g., one or more components of 5G CN 240, external client 230, or a controller) which may receive and store or use the data for positioning of at least UE 205. It is noted that while only one ng-eNB 214 is shown in FIG. 2, some embodiments may include multiple ng-eNBs 214. Base stations (e.g., gNBs 210 and/or ng-eNB 214) may communicate directly with one another via an Xn communication interface. Additionally or alternatively, base stations may communicate directly or indirectly with other components of the 5G NR network 200, such as the LMF 220 and AMF 215.

5G NR network 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 205 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 205 to other elements in 5G CN 240 and/or may support interworking of one or more protocols used by WLAN 216 and UE 205 to one or more protocols used by other elements of 5G CN 240 such as AMF 215. For example, N3IWF 250 may support IPSec tunnel establishment with UE 205, termination of IKEv2/IPSec protocols with UE 205, termination of N2 and N3 interfaces to 5G CN 240 for control plane and user plane, respectively, relaying of uplink (UL) and downlink (DL) control plane Non-Access Stratum (NAS) signaling between UE 205 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 205 and the AMF 215. As noted, this can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, and/or WLAN 216 (alone or in combination with other components of the 5G NR network 200), may be configured to, in response to receiving a request for location information from the LMF 220, obtain location measurements of uplink (UL) signals received from the UE 205) and/or obtain downlink (DL) location measurements from the UE 205 that were obtained by UE 205 for DL signals received by UE 205 from one or more access nodes. As noted, while FIG. 2 depicts access nodes (gNB 210, ng-eNB 214, and WLAN 216) configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 205, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 205 may be applicable to such other networks.

The gNBs 210 and ng-eNB 214 can communicate with an AMF 215, which, for positioning functionality, communicates with an LMF 220. The AMF 215 may support mobility of the UE 205, including cell change and handover of UE 205 from an access node (e.g., gNB 210, ng-eNB 214, or WLAN 216) of a first RAT to an access node of a second RAT. The AMF 215 may also participate in supporting a signaling connection to the UE 205 and possibly data and voice bearers for the UE 205. The LMF 220 may support positioning of the UE 205 using a CP location solution when UE 205 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Frequency Difference Of Arrival (FDOA), Real Time Kinematic (RTK), Precise Point Positioning (PPP), Differential GNSS (DGNSS), Enhanced Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 205, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 205's location) may be performed at the UE 205 (e.g., by measuring downlink PRS (DL-PRS) signals transmitted by wireless nodes such as gNBs 210, ng-eNB 214 and/or WLAN 216, and/or using assistance data provided to the UE 205, e.g., by LMF 220).

The Gateway Mobile Location Center (GMLC) 225 may support a location request for the UE 205 received from an external client 230 and may forward such a location request to the AMF 215 for forwarding by the AMF 215 to the LMF 220. A location response from the LMF 220 (e.g., containing a location estimate for the UE 205) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 205 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 205 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 205 may communicate using an LTE Positioning Protocol (LPP) as defined in 3GPP TS 37.355. Here, LPP messages may be transferred between the UE 205 and the LMF 220 via the AMF 215 and a serving gNB 210-1 or serving ng-eNB 214 for UE 205. For example, LPP messages may be transferred between the LMF 220 and the AMF 215 using messages for service-based operations (e.g., based on the Hypertext Transfer Protocol (HTTP)) and may be transferred between the AMF 215 and the UE 205 using a 5G NAS protocol. The LPP protocol may be used to support positioning of UE 205 using UE assisted and/or UE based position methods such as A-GNSS, RTK, TDOA, multi-cell RTT, AoD, and/or ECID. The NRPPa protocol may be used to support positioning of UE 205 using network-based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 205 access to WLAN 216, LMF 220 may use NRPPa and/or LPP to obtain a location of UE 205 in a similar manner to that just described for UE 205 access to a gNB 210 or ng-eNB 214. Thus, NRPPa messages may be transferred between a WLAN 216 and the LMF 220, via the AMF 215 and N3IWF 250 to support network-based positioning of UE 205 and/or transfer of other location information from WLAN 216 to LMF 220. Alternatively, NRPPa messages may be transferred between N3IWF 250 and the LMF 220, via the AMF 215, to support network-based positioning of UE 205 based on location related information and/or location measurements known to or accessible to N3IWF 250 and transferred from N3IWF 250 to LMF 220 using NRPPa. Similarly, LPP and/or LPP messages may be transferred between the UE 205 and the LMF 220 via the AMF 215, N3IWF 250, and serving WLAN 216 for UE 205 to support UE assisted or UE based positioning of UE 205 by LMF 220.

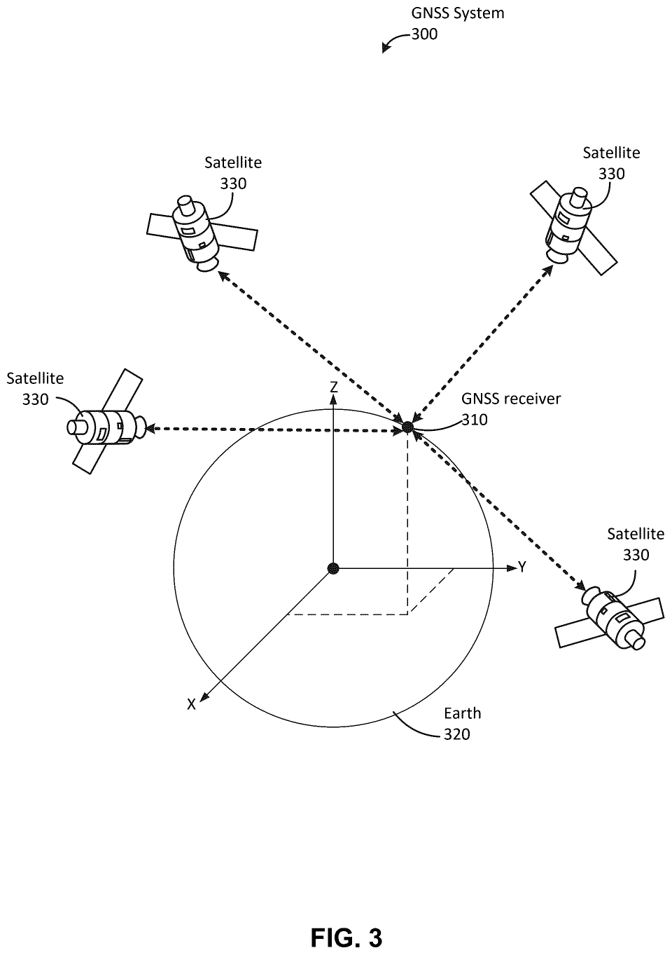

As previously noted, the satellites 110 may be used for positioning a GNSS device (also referred as a GNSS receiver). For example, FIG. 3 is a simplified diagram of a GNSS system 300, provided to illustrate how GNSS is generally used to determine an accurate location of a GNSS receiver 310 on Earth 320. Put generally, the GNSS system 300 enables an accurate GNSS position fix of the GNSS receiver 310, which receives RF signals from GNSS satellites 330 (also known as GNSS “satellite vehicles” or “SVs”; corresponding to the satellites 110 discussed in FIGS. 1 and 2) from one or more GNSS constellations. The types of GNSS receiver 310 used may vary, depending on the application. In some embodiments, for instance, the GNSS receiver 310 may comprise a standalone device or component incorporated into another device. In some embodiments, the GNSS receiver 310 may be integrated into industrial or commercial equipment, such as survey equipment, Internet of Things (IoT) devices, etc. The GNSS receiver 310 may correspond to mobile device 105 and/or UE 205 discussed in FIGS. 1 and 2.

It will be understood that the diagram provided in FIG. 3 is greatly simplified. In practice, there may be dozens of satellites 330 and a given GNSS constellation, and there are many different types of GNSS systems. As noted above, GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration/multilateration, which is a method of determining position by measuring distances to points at known coordinates. In general, the determination of the position of a GNSS receiver 310 in three dimensions may rely on a determination of the distance between the GNSS receiver 310 and four or more satellites 330. As illustrated, 3D coordinates may be based on a coordinate system (e.g., XYZ coordinates; latitude, longitude, and altitude; etc.) centered at the Earth's center of mass. A distance between each satellite 330 and the GNSS receiver 310 may be determined using precise measurements made by the GNSS receiver 310 of a difference in time from when an RF signal is transmitted from the respective satellite 330 to when it is received at the GNSS receiver 310. To help ensure accuracy, not only does the GNSS receiver 310 need to make an accurate determination of when the respective signal from each satellite 330 is received, but many additional factors need to be considered and accounted for. These factors include, for example, clock differences at the GNSS receiver 310 and satellite 330 (e.g., clock bias), a precise location of each satellite 330 at the time of transmission (e.g., as determined by the broadcast ephemeris), the impact of atmospheric distortion (e.g., ionospheric and tropospheric delays), and the like.

To perform a traditional GNSS position fix, the GNSS receiver 310 can use code-based positioning to determine its distance to each satellite 330 based on a determined delay in a generated pseudorandom binary sequence received in the RF signals received from each satellite, in consideration of the additional factors and error sources previously noted. Code-based positioning measurements for positioning in this manner may be referred to as pseudo-range (or PR) measurements. With the distance and location information of the satellites 330, the GNSS receiver 310 can then determine a position fix for its location. This position fix may be determined, for example, by a Standalone Positioning Engine (SPE) executed by one or more processors of the GNSS receiver 310. However, code-based positioning is relatively inaccurate and, without error correction, is subject to many of the previously described errors. Even so, code-based GNSS positioning can provide a positioning accuracy for the GNSS receiver 310 on the order of meters.

More accurate carrier-based ranging is based on a carrier wave of the RF signals received from each satellite, and error correction is used to help reduce errors from the previously noted error sources. Carrier-based positioning measurements for positioning in this manner may be referred to as carrier phase (or CP) measurements. Some techniques utilize differential error correction, in which errors (e.g., atmospheric error sources) in the carrier-based ranging of satellites 130 observed by the GNSS receiver 310 can be mitigated or canceled based on similar carrier-based ranging of the satellites 330 using a highly accurate GNSS receiver at the base station at a known location. These measurements and the base station's location can be provided to the GNSS receiver 310 for error correction. This position fix may be determined, for example, by a Precise Positioning Engine (PPE) executed by one or more processors of the GNSS receiver 310. More specifically, in addition to the information provided to an SPE, the PPE may use base station GNSS measurement information and additional correction information, such as troposphere and ionosphere, to provide a high-accuracy, carrier-based position fix. Several GNSS techniques can be adopted in PPE, such as Differential GNSS (DGNSS), Real-Time Kinematic (RTK), and Precise Point Positioning (PPP), and may provide a sub-meter accuracy (e.g., on the order of centimeters). (An SPE and/or PPE may be referred to herein as a GNSS positioning engine and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, using multi-frequency GNSS typically uses more power than single-frequency GNSS, e.g., processing power and battery power (e.g., to power a processor (e.g., for determining measurements), baseband processing, and/or RF processing).

Referring again to FIG. 3, the satellites 330 may be members of a single satellite constellation, i.e., a group of satellites that are part of a GNSS system, e.g., controlled by a common entity such as a government, and orbiting in complementary orbits to facilitate determining positions of entities around the world. One or more of the satellites 330 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example, L2 and L5 bands. As another example, a receiver may use separate receive chains for different signals in the same band, for example, GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication and the Ka-band (primarily uplink communications), the Ku and Ka bands used for communications satellites. The L-band is defined by IEEE as the frequency range from 1 to 2 GHz. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

As noted above, TTFF refers to the time it takes for a GNSS receiver to establish a reliable position fix which is a key performance metric in GNSS operations. The efficiency of TTFF is heavily influenced by the receiver's ability to quickly acquire and process satellite signals (signals from satellites 110 and/or satellites 330). That said, the initial signal acquisition, during which phase, the GNSS receiver searches for and locks onto satellite signals to begin computing its position, is an important phase in GNSS operations that directly impacts TTFF.

Embodiments disclosed herein improve the TTFF when satellite visibility is and/or had been compromised. Such scenarios may include geographical transitions where users move across regions, countries, or continents, potentially disrupting the alignment with available GNSS satellites. Additionally, natural calamities, war-like events, or other catastrophic conditions may cause intermittent or permanent loss of signals from one or more GNSS constellations over certain parts of the globe. Moreover, typical urban and enclosed environments such as tunnels, parking lots, and movie theatres often result in GNSS-denied zones where direct satellite signals are obstructed. These conditions present significant obstacles to maintaining continuous and reliable GNSS service, necessitating innovative approaches to ensure that GNSS receivers can still function effectively under varied and challenging circumstances.

According to the technical solutions disclosed herein, when the GNSS device losses GNSS signal(s) and starts to search for satellite signals, PLMN information indicating a region in which the GNSS device is located may be received by the GNSS device from a terrestrial network (e.g., the network 170 in FIG. 1). In some embodiments, the PLMN information may be received as a result of a request to the terrestrial network. Additionally or alternatively, the PLMN information may be broadcasted by the terrestrial network and received by the GNSS device. A coverage association mapping radio frequency signal coverages of a plurality of satellites with one or more fixed radio cells of the terrestrial network (e.g., pre-defined satellite visibility map(s)) may also be obtained by the GNSS device. In some embodiments, the coverage association may be received as a result of a request to a coordinating device as will be discussed in detail below. As discussed below, the coverage area of a fixed radio cell of the terrestrial network may have a fixed geographic coverage area, which may be defined by a PLMN operator and may comprise the interior of a circle, ellipse or a polygon. Unlike the radio frequency signal coverage of the GNSS satellites which typically change with time, the coverage area of a fixed radio cell of the terrestrial network may be fixed relative to the surface of the Earth and does not change with time. Therefore, the coverage association may need to be dynamically updated at a predetermined interval (e.g., every few minutes, 10 minutes, 20 minutes, a few hours, a few days, etc.).

In some embodiments, a list of satellites for the GNSS device may then be determined according to the coverage association and the region indicated by the PLMN information. In the list of satellites, search strategies such as a search priority and a back-off strategy for defining search intervals may be established. According to the list of satellites, one or more satellites from the list of satellites, with which the GNSS device will perform the GNSS session, may be determined by searching satellites on the list in accordance with the strategies established in the list.

In some embodiments, in scenarios where users move across regions, countries, or continents, the list of satellites including the search strategies of the GNSS device may be dynamically adjusted based on the PLMN information and the coverage association. The adjustment ensures that the GNSS device prioritizes satellites more likely to be visible given the current geographical context, thereby reducing the time required to establish a satellite link. Additionally or alternatively, for environments inherently prone to GNSS signal denial such as tunnels, parking lots, and movie theatres, the embodiments disclosed herein may employ the search strategies that quickly identify signal blockage, enabling the GNSS device to quickly switch to other positioning and/or tracking methods or wait out signal disruption with minimal power consumption. Together, the technical solutions disclosed herein significantly enhance the reliability and efficiency of GNSS services under diverse operational conditions.

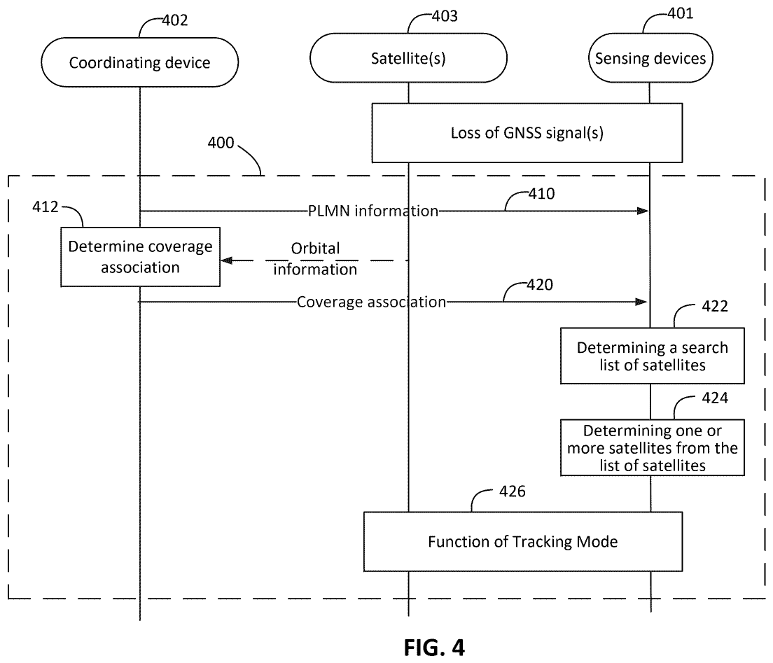

For example, FIG. 4 illustrates a call flow diagram for an improved GNSS session 400, according to some embodiments. The improved GNSS session 400 may be performed between a GNSS device 401, a coordinating device 402, and satellites 403. In some embodiments, the GNSS device 401 may correspond to mobile device 105 in FIG. 1, UE 205 in FIG. 2, and/or the GNSS receiver 310 in FIG. 3. The coordinating device 402 may correspond to a server (e.g., a location server 160, a LMF 220, AMF 215, proprietary server, or any suitable computing device) or a base station (e.g., the base station 120 in FIG. 1 and/or gNB 210 in FIG. 2). The satellites 403 may correspond to satellites 110 in FIGS. 1 and 2 and/or satellites 330 in FIG. 3.

As noted above, the improved GNSS session 400 may be performed responsive to a loss of GNSS signal(s) (e.g., a previous satellite being inaccessible to the GNSS device 401). For example, as discussed above, the loss of GNSS signals may be caused by compromised satellite visibility, either currently or previously.

Before start to search for the satellite, the improved GNSS session 400 may start at arrow 410, where the GNSS device 401 receives PLMN information from a terrestrial network. In some embodiments, the PLMN information may be received using from a physical layer of the GNSS device 401. As noted above, the PLMN information may be received as a result of a request to the terrestrial network and/or the PLMN information may be broadcasted by the terrestrial network and received by the GNSS device 401.

In some embodiments, the PLMN information indicates the region where the GNSS device 401 is located, provided by the network that serves the GNSS device 401 and is associated with the coordinating device 402. As stated above, the terrestrial network may correspond to network 170 in FIG. 1. In some embodiments, the indicated region may include a global region (e.g., a city, a country, a continent, etc.) corresponding to a rough estimate position of the GNSS device 401 with respect to one or more fixed radio cells of the terrestrial network. In some embodiments, the global region may be determined according to the serving terrestrial network.

At block 412, at a given time (e.g., Time of Week), a coverage association mapping radio frequency signal coverages of a plurality of satellites with one or more fixed radio cells of the terrestrial network may be determined by the coordinating device 402. The coverage association may be determined according to the orbital information of the plurality of satellites. The orbital information may be received from the plurality of satellites or from an intermedia device (e.g., a data source and/or base station(s)) responsive to a request.

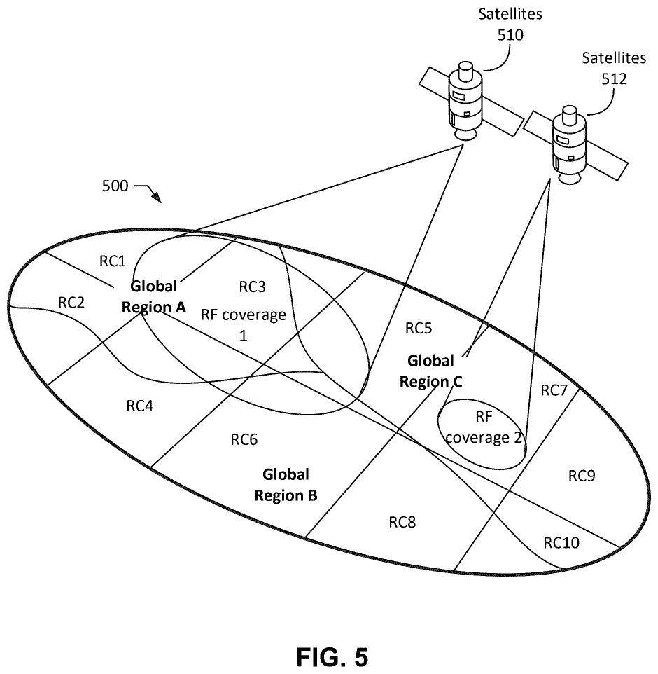

For example, FIG. 5 illustrates a coverage association 500 mapping radio frequency signal coverages of the plurality of satellites with one or more fixed radio cells of the terrestrial network, according to some embodiments. A first and a second set of satellites 510 and 512 may correspond to satellites 110 in FIGS. 1 and 2, satellites 330 in FIG. 3, and/or satellites 403 in FIG. 4. It will be understood that coverage association 500 provided in FIG. 5 is greatly simplified. In practice, there may be dozens of fixed radio cells and RF signal coverages that corresponds to multiple set of satellites.

As shown in FIG. 5, the first set of satellites 510 may have a corresponding RF signal coverage (e.g., RF coverage 1) and the second set of satellites 512 may have a corresponding RF signal coverage (e.g., RF coverage 2). As discussed above, each of the coverage areas of fixed radio cells of the terrestrial network (e.g., RC1, RC2, . . . . RC 10) may have a fixed geographic coverage area, which may be defined by a PLMN operator and may comprise the interior of a circle, ellipse or a polygon. In some embodiments, the coverage area of fixed radio cells of the terrestrial network may correspond to different global regions (e.g., global region A, global region B, and global region C).

As shown in FIG. 5, at a given time, based on the orbital information of the first and the second set of satellites 510 and 512, which may be received from the first and the second set of satellites 510 and 512 or from an intermedia device (e.g., one or more data source and/or base station(s)) responsive to a request, the coverage association 500 mapping the RF coverage 1 and the RF coverage 2 to RC1, RC2, . . . . RC 10 may be determined (e.g., according to one or more functions). As noted above, unlike the radio frequency signal coverage of the GNSS satellites (e.g., the RF coverage 1 and the RF coverage 2) which typically change with time, the coverage area of the fixed radio cells of the terrestrial network (e.g., RC1, RC2, . . . . RC 10) may be fixed relative to the surface of the Earth and does not change with time. Therefore, the coverage association may need to be dynamically updated at a predetermined interval (e.g., every few minutes, 10 minutes, 20 minutes, a few hours, a few days, etc.).

Referring back to FIG. 4, at block 420, the coverage association may be obtained by the GNSS device 401. In some embodiments, the coverage association may be transmitted to the GNSS device 401 responsive to a request (not shown) made by the GNSS device 401.

At block 422, the GNSS device 401 may determine a list of satellites for searching satellites with which the GNSS device 401 will perform the GNSS session, based on the coverage association (e.g., the coverage association 500 in FIG. 5) and the region indicated by the PLMN information. For example, as shown in FIG. 5, if the PLMN information indicates that the GNSS device 401 may be located in global region C, which is mapped to the radio frequency signal coverage of both the first and the second set of satellites 510 and 512 according to the coverage association 500, the list of satellites may include and prioritize at least the first and the second set of satellites 510 and 512. In some embodiments, the list of satellites may also be in the form of a look-up table.

In some embodiments, the list of satellites may include an search order (e.g., the priority for searching) and a back-off strategy (e.g., defining intervals between different searching attempts). At block 424 in FIG. 4, the GNSS device 401 may determine one or more satellites from the list with which to perform a GNSS session by searching satellites on the list in accordance with a priority established in the list. For example, according to the list, the GNSS device 401 may start the search by searching the first set of satellites 510. If peaks in the satellite signal strength are detected (e.g., indicating successful reception of the signal from the first set of satellites 510), the GNSS device 401 may perform the GNSS session with the first set of satellites 510 (e.g., performing the function of a tracking mode), as shown in block 426 in FIG. 4. If no GNSS signal (e.g., GNSS signal with a strength higher than a predetermined threshold) is detected, after a predetermined time interval, the GNSS device 401 may start to search for the second set of satellites 512. Similarly, if peaks in the satellite signal strength are detected, the GNSS device 401 may perform the GNSS session with the second set of satellites 512, as shown in block 426 in FIG. 4. Again, if no GNSS signal (e.g., GNSS signal with a strength higher than a predetermined threshold) is detected, after another predetermined time interval, the GNSS device 401 may start to search for the first set of satellites 510 again.

In some embodiments, as stated above, the list of satellite may also establish a back-off strategy defining search interval between each search attempt. For example, when searching the satellite according to the priority established in the list, the predetermined search interval between each search, according to the back-off strategy, may include intervals that are constant, linearly increasing, exponentially increasing, or any combination thereof.

In some embodiments, the back-off strategy may also define a time period to stop searching after performing a predetermined number of search attempts (e.g., the total time allocated for searching the satellite from the list is limited to a predetermined maximum). Additionally or alternatively, the strategy may define an upper limit on the number of search attempts for the satellites (e.g., the number of attempts is limited to a predetermined maximum). As stated above, this may reduce the power consumption when searching for GNSS signals in environments inherently prone to GNSS signal denial. In some embodiments, the back-off strategy may limit the number of satellites from the list that the GNSS device 401 should attempt to search for. For example, although the list may include more than two sets of satellites, the GNSS device 401 may only be permitted to search for the top two sets of satellites.

It is noted that the specific example discussed herein, which includes only the first and second sets of satellites 510 and 512 and fixed radio cells from RC1 to RC10, is for illustrative purposes only. More sets of satellites and fixed radio cells can be included in the coverage association and/or the list. Additionally, search strategies established in the list, such as the search order and the back-off strategy, may also be modified for desired performance. For example, if searching for the second set of satellites 512 fails, the GNSS device 401 may then search for a third set of satellites on the list of satellites.

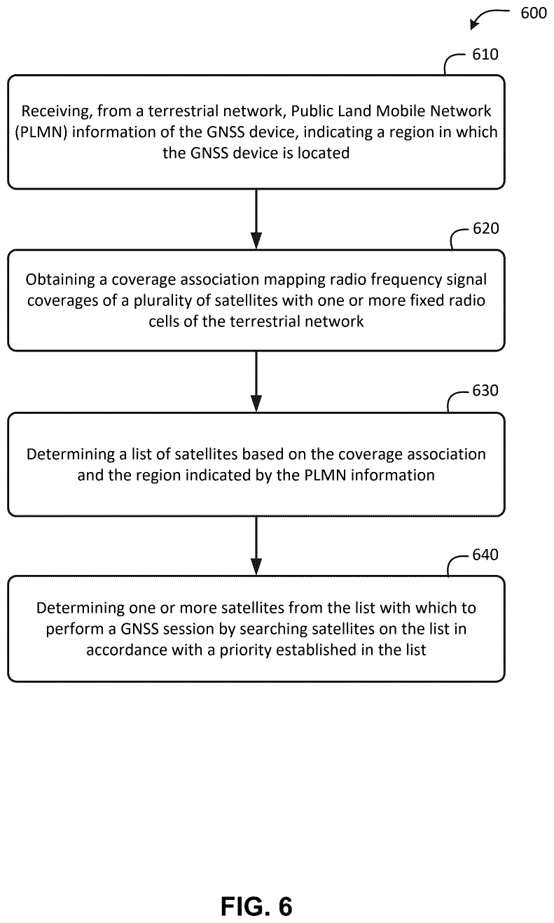

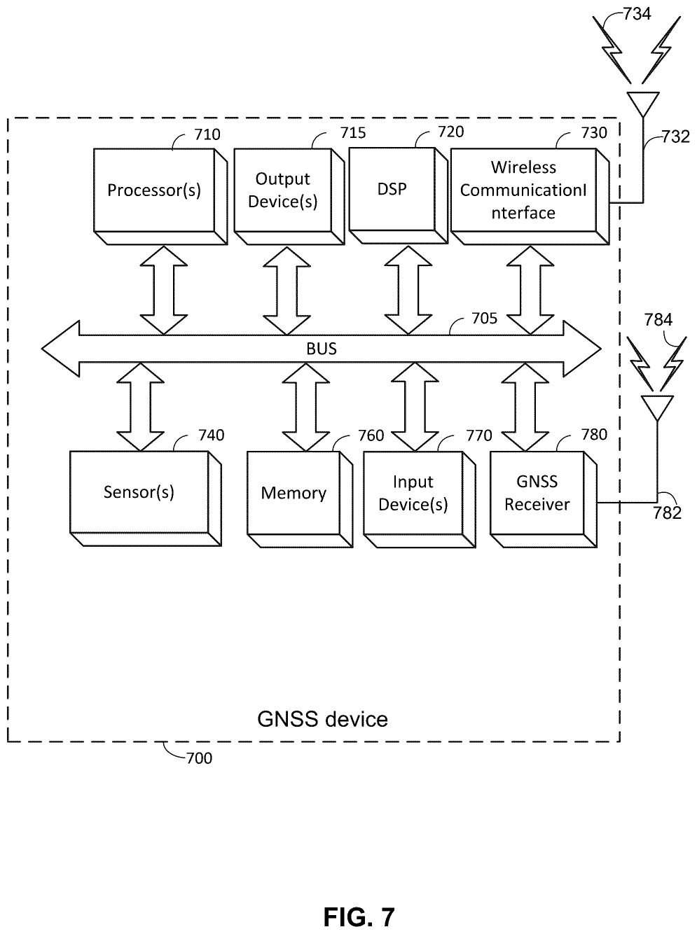

FIG. 6 is a flow diagram of a method of the improved GNSS session illustrated in FIG. 4, performed by a GNSS device, according to some embodiments. According to aspects of the disclosure, means for performing the functionality illustrated in one or more of the blocks shown in FIG. 6 may be performed by hardware and/or software components of a GNSS device (which may comprise a mobile device, base station, or other device comprising and/or communicatively coupled with a GNSS receiver). Example components of a GNSS device are illustrated in FIG. 7, which is described in more detail below.

At block 610, the functionality comprises receiving, from a terrestrial network, Public Land Mobile Network (PLMN) information of the GNSS device, indicating a region in which the GNSS device is located.

Means for performing functionality at block 610 may comprise a bus 705, processor(s) 710, digital signal processor (DSP) 720, memory/memories 760, GNSS receiver 780, and/or other components of a GNSS device 700, as illustrated in FIG. 7, for example.

At block 620, the functionality comprises obtaining a coverage association mapping radio frequency signal coverages of a plurality of satellites with one or more fixed radio cells of the terrestrial network. The coverage association may be determined based on orbital information of the plurality of satellites.

Means for performing functionality at block 620 may comprise a bus 705, processor(s) 710, digital signal processor (DSP) 720, memory/memories 760, GNSS receiver 780, and/or other components of a GNSS device 700, as illustrated in FIG. 7, for example.

At block 630, the functionality comprises determining a list of satellites based on the coverage association and the region indicated by the PLMN information.

Means for performing functionality at block 630 may comprise a bus 705, processor(s) 710, digital signal processor (DSP) 720, memory/memories 760, GNSS receiver 780, and/or other components of a GNSS device 700, as illustrated in FIG. 7, for example.

At block 640, the functionality comprises determining one or more satellites from the list with which to perform a GNSS session by searching satellites on the list in accordance with a priority established in the list.

Means for performing functionality at block 640 may comprise a bus 705, processor(s) 710, digital signal processor (DSP) 720, memory/memories 760, GNSS receiver 780, and/or other components of a GNSS device 700, as illustrated in FIG. 7, for example.

In some embodiments, receiving PLMN information of the GNSS device was performed responsive to GNSS signals from a previous satellite being inaccessible to the GNSS device. As noted about, the PLMN information may be received as a result of a request to the terrestrial network and/or the PLMN information may be broadcasted by the terrestrial network and received by the GNSS device. In some embodiments, the PLMN information may be received using from a physical layer of the GNSS device.

In some embodiments, method 600 may further include dynamically adjusting the coverage association based on the orbital information of the plurality of satellites, at a predetermined interval (e.g., every few minutes, 10 minutes, 20 minutes, a few hours, a few days, etc.).

In some embodiments, searching the satellite according to the priority established in the list may include searching no more than a predetermined number of satellites from the list.

In some embodiments, when searching the satellite according to the priority established in the list, a search interval between each search attempt is defined by a back-off strategy, the back-off strategy may include intervals that are constant, linearly increasing, exponentially increasing, or any combination thereof.

In some embodiments, a number of search attempts for searching the satellite from the list is limited to a predetermined maximum.

In some embodiments, a total time allocated for searching the satellite from the list is limited to a predetermined maximum.

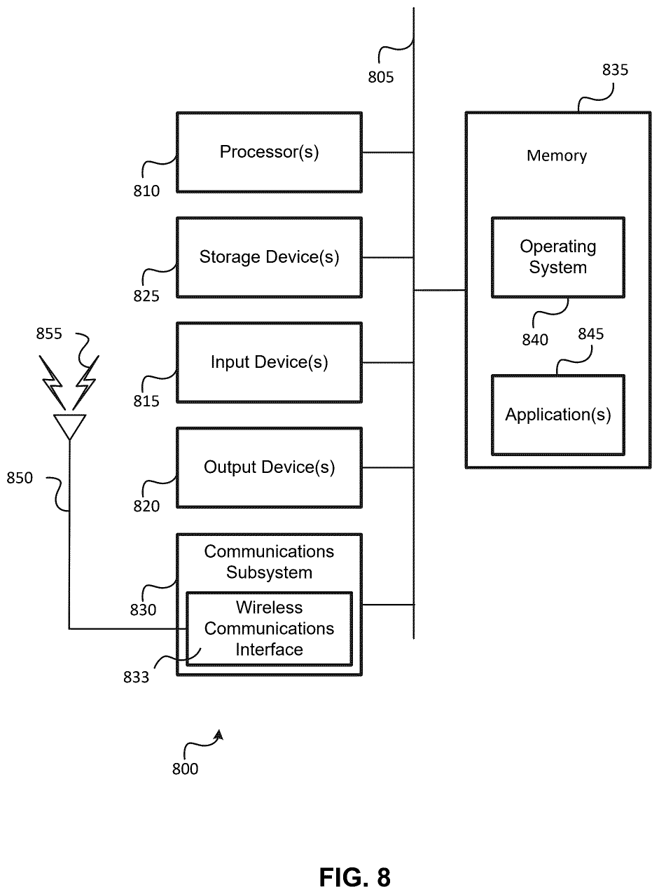

FIG. 7 is a block diagram of an embodiment of a GNSS device 700, which can be utilized as described herein above (e.g., in association with mobile device 105 in FIG. 1, UE 205 in FIG. 2, the GNSS receiver 310 in FIG. 3, and/or GNSS device 401 in FIG. 4). For example, the GNSS device 700 can perform one or more of the functions of the method shown in FIG. 8, in cases in which the configuring device corresponds to a sensing device and in cases in which the configuring device corresponds to a base station. It should be noted that FIG. 7 is meant only to provide a generalized illustration of various components, any or all of which may be utilized as appropriate. It can be noted that, in some instances, components illustrated by FIG. 7 can be localized to a single physical device and/or distributed among various networked devices, which may be disposed at different physical locations. Furthermore, as previously noted, the functionality of the sensing device discussed in the previously described embodiments may be executed by one or more of the hardware and/or software components illustrated in FIG. 7.

The GNSS device 700 is shown comprising hardware elements that can be electrically coupled via a bus 705 (or may otherwise be in communication, as appropriate). The hardware elements may include a processor(s) 710 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 710 may comprise one or more processing units, which may be housed in a single integrated circuit (IC) or multiple ICs. As shown in FIG. 7, some embodiments may have a separate DSP 720, depending on desired functionality. Location determination and/or other determinations based on wireless communication may be provided in the processor(s) 710 and/or wireless communication interface 730 (discussed below). The GNSS device 700 also can include one or more input devices 770, which can include without limitation one or more keyboards, touch screens, touch pads, microphones, buttons, dials, switches, and/or the like; and one or more output devices 715, which can include without limitation one or more displays (e.g., touch screens), light emitting diodes (LEDs), speakers, and/or the like.

The GNSS device 700 may also include a wireless communication interface 730, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the GNSS device 700 to communicate with other devices as described in the embodiments above. The wireless communication interface 730 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 732 that send and/or receive wireless signals 734. According to some embodiments, the wireless communication antenna(s) 732 may comprise a plurality of discrete antennas, antenna arrays, or any combination thereof. The antenna(s) 732 may be capable of transmitting and receiving wireless signals using beams (e.g., Tx beams and Rx beams). Beam formation may be performed using digital and/or analog beam formation techniques, with respective digital and/or analog circuitry. The wireless communication interface 730 may include such circuitry.

Depending on desired functionality, the wireless communication interface 730 may comprise a separate receiver and transmitter, or any combination of transceivers, transmitters, and/or receivers to communicate with base stations (e.g., ng-eNBs and gNBs) and other terrestrial transceivers, such as wireless devices and access points. The GNSS device 700 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The GNSS device 700 can further include sensor(s) 740. Sensor(s) 740 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the GNSS device 700 may also include a Global Navigation Satellite System (GNSS) receiver 780 capable of receiving signals 784 from one or more GNSS satellites using an antenna 782 (which could be the same as antenna 732). Positioning based on GNSS signal measurement can be utilized to complement and/or incorporate the techniques described herein. The GNSS receiver 780 can extract a position of the GNSS device 700, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 780 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 780 is illustrated in FIG. 7 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 710, DSP 720, and/or a processor within the wireless communication interface 730 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 710 or DSP 720.

The GNSS device 700 may further include and/or be in communication with a memory 760. The memory 760 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 760 of the sensing GNSS 700 also can comprise software elements (not shown in FIG. 7), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 760 that are executable by the GNSS device 700 (and/or processor(s) 710 or DSP 720 within GNSS device 700). In some embodiments, then, such code and/or instructions can be used to configure and/or adapt a general-purpose computer (or other device) to perform one or more operations in accordance with the described methods.

FIG. 8 is a block diagram of an embodiment of a computer system 800, which may be used, in whole or in part, to provide the functions of one or more network components as described in the embodiments herein (e.g., location server 160 in FIG. 1 or 2, or coordinating device 402 in FIG. 4). It should be noted that FIG. 8 is meant only to provide a generalized illustration of various components, any or all of which may be utilized as appropriate. FIG. 8, therefore, broadly illustrates how individual system elements may be implemented in a relatively separated or relatively more integrated manner. In addition, it can be noted that components illustrated by FIG. 8 can be localized to a single device and/or distributed among various networked devices, which may be disposed at different geographical locations.

The computer system 800 is shown comprising hardware elements that can be electrically coupled via a bus 805 (or may otherwise be in communication, as appropriate). The hardware elements may include processor(s) 810, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 800 also may comprise one or more input devices 815, which may comprise without limitation a mouse, a keyboard, a camera, a microphone, and/or the like; and one or more output devices 820, which may comprise without limitation a display device, a printer, and/or the like.

The computer system 800 may further include (and/or be in communication with) one or more non-transitory storage devices 825, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 800 may also include a communications subsystem 830, which may comprise wireless communication technologies managed and controlled by a wireless communication interface 833, as well as wired technologies (such as Ethernet, coaxial communications, universal serial bus (USB), and the like). The wireless communication interface 833 may comprise one or more wireless transceivers that may send and receive wireless signals 855 (e.g., signals according to 5G NR or LTE) via wireless antenna(s) 850. Thus the communications subsystem 830 may comprise a modem, a network card (wireless or wired), an infrared communication device, a wireless communication device, and/or a chipset, and/or the like, which may enable the computer system 800 to communicate on any or all of the communication networks described herein to any device on the respective network, including a User Equipment (UE), base stations and/or other TRPs, and/or any other electronic devices described herein. Hence, the communications subsystem 830 may be used to receive and send data as described in the embodiments herein.

In many embodiments, the computer system 800 will further comprise a working memory 835, which may comprise a RAM or ROM device, as described above. Software elements, shown as being located within the working memory 835, may comprise an operating system 840, device drivers, executable libraries, and/or other code, such as one or more applications 845, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code may be stored on a non-transitory computer-readable storage medium, such as the storage device(s) 825 described above. In some cases, the storage medium may be incorporated within a computer system, such as computer system 800. In other embodiments, the storage medium may be separate from a computer system (e.g., a removable medium, such as an optical disc), and/or provided in an installation package, such that the storage medium can be used to program, configure, and/or adapt a general purpose computer with the instructions/code stored thereon. These instructions may take the form of executable code, which is executable by the computer system 800 and/or may take the form of source and/or installable code, which, upon compilation and/or installation on the computer system 800 (e.g., using any of a variety of generally available compilers, installation programs, compression/decompression utilities, etc.), then takes the form of executable code.

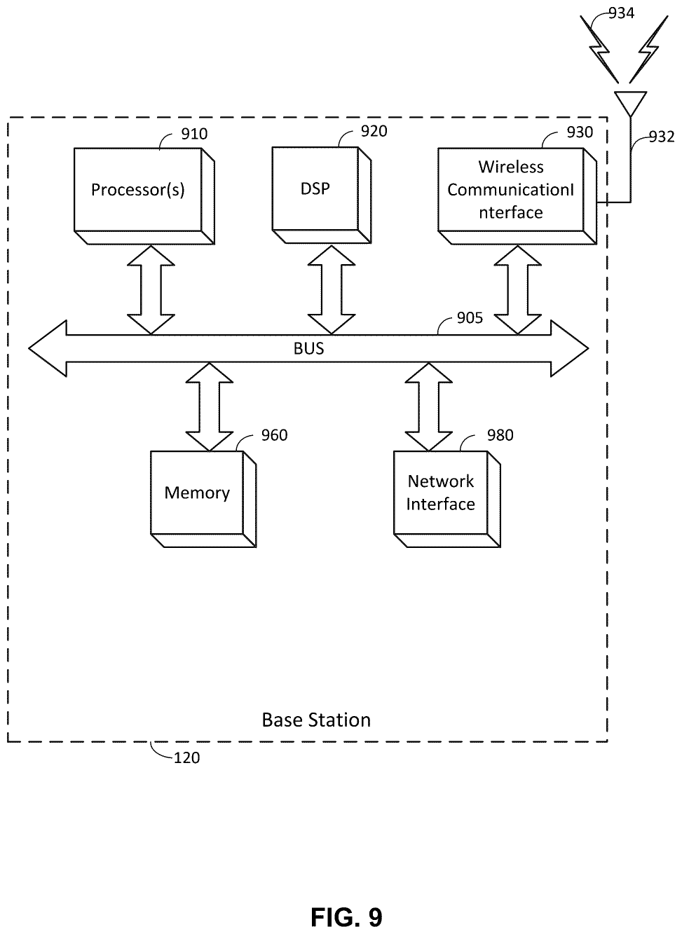

FIG. 9 is a block diagram of an embodiment of a base station 120, which can be utilized as described herein above (e.g., in association with a base station 120 in FIG. 1 and/or a gNB 210 in FIG. 2). It should be noted that FIG. 9 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 905 (or may otherwise be in communication, as appropriate). The hardware elements may include a processor(s) 910 which can include without limitation one or more general-purpose processors, one or more special-purpose processors (such as DSP chips, graphics acceleration processors, ASICs, and/or the like), and/or other processing structure or means. As shown in FIG. 9, some embodiments may have a separate DSP 920, depending on desired functionality. Location determination and/or other determinations based on wireless communication may be provided in the processor(s) 910 and/or wireless communication interface 930 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 930 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 932 that send and/or receive wireless signals 934.

The base station 120 may also include a network interface 980, which can include support of wireline communication technologies. The network interface 980 may include a modem, network card, chipset, and/or the like. The network interface 980 may include one or more input and/or output communication interfaces to permit data to be exchanged with a network, communication network servers, computer systems, and/or any other electronic devices described herein.

In many embodiments, the base station 120 may further comprise a memory 960. The memory 960 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 960 of the base station 120 also may comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the base station 120 (and/or processor(s) 910 or DSP 920 within base station 120). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware may also be used and/or particular elements may be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media may be involved in providing instructions/code to processors and/or other device(s) for execution. Additionally or alternatively, the machine-readable media may be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. An example method for Global Navigation Satellite System (GNSS)-based positioning performed by a GNSS device, the method may include receiving, from a terrestrial network, Public Land Mobile Network (PLMN) information of the GNSS device, indicating a region in which the GNSS device is located and obtaining a coverage association mapping radio frequency signal coverages of a plurality of satellites with one or more fixed radio cells of the terrestrial network, wherein the coverage association is determined based on orbital information of the plurality of satellites. The method may also include determining a list of satellites based on the coverage association and the region indicated by the PLMN information and determining one or more satellites from the list with which to perform a GNSS session by searching satellites on the list in accordance with a priority established in the list.
Clause 2. The method of clause 1, wherein receiving PLMN information of the GNSS device was performed responsive to GNSS signals from a previous satellite being inaccessible to the GNSS device.
Clause 3. The method of clause 1 or 2, wherein the PLMN information is received from a physical layer of the GNSS device.
Clause 4. The method of any of clauses 1-3, further comprising: dynamically adjusting the coverage association based on the orbital information of the plurality of satellites.
Clause 5. The method of any of clauses 1-4, wherein searching the satellite according to the priority established in the list comprises: searching no more than a predetermined number of satellites from the list.
Clause 6. The method of any of clauses 1-5, wherein when searching the satellite according to the priority established in the list, a search interval between each search attempt is defined by a back-off strategy established in the list, the back-off strategy comprising intervals that are: constant; linearly increasing; exponentially increasing; or any combination thereof.
Clause 7. The method of any clauses 1-6, wherein a number of search attempts for searching the satellite from the list is limited to a predetermined maximum.
Clause 8. The method of any of clauses 1-7, wherein a total time allocated for searching the satellite from the list is limited to a predetermined maximum.
Clause 9. An example Global Navigation Satellite System (GNSS) device for GNSS-based positioning may comprise one or more transceivers, one or more memories, and one or more processors communicatively coupled with the one or more transceivers and the one or more memories. The one or more processors may be configured to receive, from a terrestrial network, Public Land Mobile Network (PLMN) information of the GNSS device, indicating a region in which the GNSS device is located and obtain a coverage association mapping radio frequency signal coverages of a plurality of satellites with one or more fixed radio cells of the terrestrial network, wherein the coverage association is determined based on orbital information of the plurality of satellites. The one or more processors may also be configured determine a list of satellites based on the coverage association and the region indicated by the PLMN information and determine one or more satellites from the list with which to perform a GNSS session by searching satellites on the list in accordance with a priority established in the list.
Clause 10. The GNSS device of clause 9, wherein the PLMN information of the GNSS device was received responsive to GNSS signals from a previous satellite being inaccessible to the GNSS device.
Clause 11. The GNSS device of clause 9 or 10, wherein the PLMN information is received from a physical layer of the GNSS device.
Clause 12. The GNSS device of any of clauses 9-11, wherein the one or more processors are further configured to: dynamically adjusting the coverage association based on the orbital information of the plurality of satellites.
Clause 13. The GNSS device of any of clauses 9-12, wherein to search the satellite according to the priority established in the list, the one or more processors are further configured to: search no more than a predetermined number of satellites from the list.
Clause 14. The GNSS device of any of clauses 9-13, wherein when searching the satellite according to the priority established in the list, a search interval between each search attempt is defined by a back-off strategy established in the list, the back-off strategy comprising intervals that are: constant; linearly increasing; exponentially increasing; or any combination thereof.
Clause 15. The GNSS device of any of clauses 9-14, wherein a number of search attempts for searching the satellite from the list is limited to a predetermined maximum.
Clause 16. The GNSS device of any of clauses 9-15, wherein a total time allocated for searching the satellite from the list is limited to a predetermined maximum.
Clause 17. An example apparatus for Global Navigation Satellite System (GNSS)-based positioning, the method may include means for receiving, from a terrestrial network, Public Land Mobile Network (PLMN) information of the apparatus, indicating a region in which the GNSS device is located and means for obtaining a coverage association mapping radio frequency signal coverages of a plurality of satellites with one or more fixed radio cells of the terrestrial network, wherein the coverage association is determined based on orbital information of the plurality of satellites. The apparatus may also include means for determining a list of satellites based on the coverage association and the region indicated by the PLMN information and means for determining one or more satellites from the list with which to perform a GNSS session by searching satellites on the list in accordance with a priority established in the list.
Clause 18. The apparatus of clause 19, wherein receiving PLMN information of the GNSS device was performed responsive to GNSS signals from a previous satellite being inaccessible to the GNSS device.
Clause 19. The apparatus of clause 18 or 19, wherein the PLMN information is received from a physical layer of the GNSS device.
Clause 20. The apparatus of any of clauses 18-20, further comprising means for dynamically adjusting the coverage association based on the orbital information of the plurality of satellites.

What is claimed is:

1. A method for Global Navigation Satellite System (GNSS)-based positioning performed by a GNSS device, the method comprising:
receiving, from a terrestrial network, Public Land Mobile Network (PLMN) information of the GNSS device, indicating a region in which the GNSS device is located;
obtaining a coverage association mapping radio frequency signal coverages of a plurality of satellites with one or more fixed radio cells of the terrestrial network, wherein the coverage association is determined based on orbital information of the plurality of satellites;
determining a list of satellites based on the coverage association and the region indicated by the PLMN information; and
determining one or more satellites from the list with which to perform a GNSS session by searching satellites on the list in accordance with a priority established in the list.

2. The method of claim 1, wherein receiving PLMN information of the GNSS device was performed responsive to GNSS signals from a previous satellite being inaccessible to the GNSS device.

3. The method of claim 1, wherein the PLMN information is received from a physical layer of the GNSS device.

4. The method of claim 1, further comprising:
dynamically adjusting the coverage association based on the orbital information of the plurality of satellites.

5. The method of claim 1, wherein searching the satellite according to the priority established in the list comprises:
searching no more than a predetermined number of satellites from the list.

6. The method of claim 1, wherein when searching the satellite according to the priority established in the list, a search interval between each search attempt is defined by a back-off strategy established in the list, the back-off strategy comprising intervals that are:
constant;
linearly increasing;
exponentially increasing; or
any combination thereof.

7. The method of claim 1, wherein a number of search attempts for searching the satellite from the list is limited to a predetermined maximum.

8. The method of claim 1, wherein a total time allocated for searching the satellite from the list is limited to a predetermined maximum.

9. A Global Navigation Satellite System (GNSS) device for GNSS-based positioning, comprising:
one or more transceivers;
one or more memories; and
one or more processors communicatively coupled with the one or more transceivers and the one or more memories, wherein the one or more processors are configured to:
receive, from a terrestrial network, Public Land Mobile Network (PLMN) information of the GNSS device, indicating a region in which the GNSS device is located;
obtain a coverage association mapping radio frequency signal coverages of a plurality of satellites with one or more fixed radio cells of the terrestrial network, wherein the coverage association is determined based on orbital information of the plurality of satellites;
determine a list of satellites based on the coverage association and the region indicated by the PLMN information; and
determine one or more satellites from the list with which to perform a GNSS session by searching satellites on the list in accordance with a priority established in the list.

10. The GNSS device of claim 9, wherein the PLMN information of the GNSS device was received responsive to GNSS signals from a previous satellite being inaccessible to the GNSS device.

11. The GNSS device of claim 9, wherein the PLMN information is received from a physical layer of the GNSS device.

12. The GNSS device of claim 9, wherein the one or more processors are further configured to:
dynamically adjust the coverage association based on the orbital information of the plurality of satellites.

13. The GNSS device of claim 9, wherein to search the satellite according to the priority established in the list, the one or more processors are further configured to:
search no more than a predetermined number of satellites from the list.

14. The GNSS device of claim 9, wherein when searching the satellite according to the priority established in the list, a search interval between each search attempt is defined by a back-off strategy established in the list, the back-off strategy comprising intervals that are:
constant;
linearly increasing;
exponentially increasing; or
any combination thereof.

15. The GNSS device of claim 9, wherein a number of search attempts for searching the satellite from the list is limited to a predetermined maximum.

16. The GNSS device of claim 9, wherein a total time allocated for searching the satellite from the list is limited to a predetermined maximum.

17. An apparatus for Global Navigation Satellite System (GNSS)-based positioning, the apparatus comprising:
means for receiving, from a terrestrial network, Public Land Mobile Network (PLMN) information of the apparatus, indicating a region in which the apparatus is located;
means for obtaining a coverage association mapping radio frequency signal coverages of a plurality of satellites with one or more fixed radio cells of the terrestrial network, wherein the coverage association is determined based on orbital information of the plurality of satellites;
means for determining a list of satellites based on the coverage association and the region indicated by the PLMN information; and
means for determining one or more satellites from the list with which to perform a GNSS session by searching satellites on the list in accordance with a priority established in the list.

18. The apparatus of claim 17, wherein receiving PLMN information of the apparatus was performed responsive to GNSS signals from a previous satellite being inaccessible to the apparatus.

19. The apparatus of claim 17, wherein the PLMN information is received from a physical layer of the apparatus.

20. The apparatus of claim 17, further comprising:
means for dynamically adjusting the coverage association based on the orbital information of the plurality of satellites.
